(19) United States
(12) Patent Application Publication
(10) Pub. No.: US 2006/0056381 A1
(43) Pub. Date: Mar. 16, 2006

(54) Mobile communication system and packet processing method thereof

(75) Inventor: Dae-Won Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/209,785

(22) Filed: Aug. 24, 2005

(30) Foreign Application Priority Data
Aug. 25, 2004 (KR) 2004-67289

(51) Int. Cl. H04J 3/24

(52) U.S. Cl. 370/349

(57) ABSTRACT

A mobile communication system and a packet processing method thereof are provided. A packet data serving node (PDSN) analyzes an Internet Protocol (IP) packet received from a service providing server, and if the IP packet is selected to be transmitted over a short data burst (SDB) channel, marks the IP packet for transmission over the short data burst (SDB) channel and transmits it to a base station/packet control function (BS/PCF).

### CLAIM OF PRIORITY

This application claims the benefit under 35 U.S.C. §119(a) from an application filed in the Korean Intellectual Property Office on Aug. 25, 2004 and assigned Serial No. 2004-67289, the entire contents of which are hereby incorporated by reference.

### BACKGROUND OF THE INVENTION

1. Field of the Invention

The present invention relates to a push-to-talk (PTT) service of a mobile communication system. More particularly, the present invention relates to a mobile communication system which can reduce a call set up time by transmitting a signaling message over a short data burst (SDB) channel when setting up a call with a dormant mobile station in order to provide the PTT service in a Code Division Multiple Access (CDMA) 2000 network, and a packet processing method thereof.

2. Description of the Related Art

Code Division Multiple Access (CDMA) 2000 1×, which evolved from IS-95 A and B, is a method of providing data service that can transfer data at a maximum speed of 153.6 kbps. CDMA 2000 1× can provide multimedia services such as audio on demand (AOD) and video on demand (VOD), wireless application protocol (WAP) service having an improved quality, as well as a voice call service.

CDMA 2000 evolution-data only (EV-DO) is a network upgraded from CDMA 2000 1× and provides data such as VOD over a dedicated channel at a maximum speed of 2.4 Mbps.

Push to Talk (PTT) service is similar to an instant messenger service such as a radio service e.g., walkie talkie or citizens band (CB) radio because it enables PTT service subscribers to instantly communicate with one another by pushing a button of a PTT terminal and talking. PTT service enables very rapid communication compared to a cellular phone call service which has a standby time in terms of dialing a phone, connecting a call and receiving audible ringback. PTT service can be provided to a specific group of subscribers such that a plurality of subscribers can all hear another subscriber through their PTT terminals at the same time. Thus, PTT service is not limited to one-on-one communication like cellular phone service. Here, a PTT service subscriber can designate a small- to medium-sized group of subscribers for group communication, or only one subscriber for one-on-one communication.

PTT service enables 1:N transmission of data using session initiation protocol (SIP).

PTT service is based on SIP, which is a text-based application level protocol. SIP has a simple structure and excellent extendibility compared to other protocols, and thus is currently employed in many systems. SIP is a signaling protocol used to connect a session. SIP can be used in a video telephone, multimedia, on-line games, and an Internet telephone. Requests For Comments (RFC) have been incorporated into the SIP as a standard that started with RFC 2543 and has been updated to RFC 3261.

In order to implement PTT service in a CDMA 2000 1× system or a CDMA 2000 1× EV-DO system, a mobile station should be able to receive data. To this end, a packet data service node (PDSN) should use an always-on function to maintain a data session.

In the CDMA 2000 First Evolution Data Only (1×/EV-DO) system, the PDSN is located between the packet control function (PCF) and the gateway router and receives a packet from the PCF and transfers the packet to the Internet or an internal/external network

In the CDMA 2000 1×/EV-DO system, the PCF is a component for transferring a packet between the base station controller (BSC) and the PDSN, and managing a call.

The always-on function enables the mobile station to transition to a dormant state to maintain an allocated traffic channel. The always-on function prevents signal loss, traffic channel allocation failure, or call disconnection, which may occur when the mobile station transitions from an active state to a dormant state or from a dormant state to an active state, so that stable data service can be provided. Also, in order to keep the mobile station in the active state, the PDSN periodically transmits an echo request packet to the mobile station. The always-on function can be used as a value-added service of the PDSN.

The always-on function does not disconnect a call even when a peer-to-peer protocol (PPP) idle timeout occurs due to absence of data transmission and reception after the mobile station establishes a data session.

The PPP protocol was devised to be used for a point-to-point connection (see RFC 1661/1662).

The PDSN periodically transmits the PPP echo request message to the mobile station using the always-on function. If the mobile station responds to the PPP echo request message transmitted from the PDSN using a PPP echo reply message, a data session remains connected.

Here, the CDMA 2000 1×/EV-DO system drives a dormant timer to efficiently use wireless resources. If no data is transmitted between the mobile station and the PDSN during the dormant timer value, the traffic channel is released and allocated to other mobile stations and a communication session enters the dormant state. At this time, the mobile station and the PDSN maintain the session information, and the mobile station remains in the dormant state in which it does not occupy the traffic channel. The mobile station requests a traffic channel only when it has data to send, and then transmits the data over the allocated traffic channel.

When a packet is transmitted from the mobile station or the Internet, the base station controller (BSC) reallocates a traffic channel to the mobile station in the dormant state thereby reactivating the mobile station.

The base station transceiver system (BTS) represents a base station system containing the antenna in the CDMA system, and performs signaling with the BSC, traffic transfer, air traffic resource management, and management of mobile station's location and state.

The BSC manages the base station in the CDMA network and transfers traffic between the mobile station and another node by transferring a call processing signal in connection with the mobile switching center (MSC) or the PCF.

In order for the CDMA 2000 1×/EV-DO system to support PTT service, the PDSN should always maintain a data session using the always-on function so that the mobile station can receive data. Thus, while the PTT mobile station does not receive or transmit data, the dormant state is continuously maintained.

A long period of time is required to allocate a traffic channel for the mobile station to transmit data for the PTT service in the dormant state.

An activation procedure is a procedure through which the mobile station is allocated a traffic channel and activated in order to transmit data.

The PTT server transmits a signaling message (e.g., Invite or 200 OK) to the mobile station to establish a SIP session. At this time, if the data session is in the dormant state, the BTS should establish a traffic channel again. Since a long time is required to allocate the traffic channel, the total call setup time is long, and thus there is a problem in performing a real-time PTT service.

### SUMMARY OF THE INVENTION

It is an exemplary object of the present invention to provide a mobile communication system which transmits a signaling message for session establishment to a mobile station in a dormant state without activating the mobile station but rather maintaining its dormant state, and a packet processing method thereof.

According to an exemplary aspect of the present invention, there is provided a packet data serving node (PDSN) which interworks with a service providing server and a base station/packet control function (BS/PCF), wherein the PDSN analyzes a predetermined Internet Protocol (IP) packet received from the service providing server, and marks the IP packet for transmission over a short data burst (SDB) channel and transmits the marked IP packet to the BS/PCF when the IP packet is selected as a packet to be transmitted over the SDB channel.

The IP packet may comprise a signaling message for session initiation protocol (SIP) session establishment transmitted from the service providing server. The signaling message may comprise a session request message or a 200 OK message.

The PDSN may further comprise a storage portion for storing and managing list information of service providing servers which are authenticated to use a service for transmitting over the SDB channel and an effective packet size, and a controller for extracting and analyzing information related to the IP packet received from the service providing server and comparing the information with a value stored in the storage portion to determine whether the corresponding IP packet is to be transmitted over the SDB channel.

The PDSN may further comprise a marking processor for receiving a packet selected to be transmitted over the SDB channel from the controller and performing generic routing encapsulation (GRE) encapsulation by providing an indication that the packet is an SDB message to be transmitted over the SDB channel onto the IP packet.

The storage portion may store an IP address list of the service providing server, a netmask, and packet length range information in the form of a table.

The controller may determine the IP packet to be transmitted over the SDB channel when a source IP address extracted from the received IP packet is contained in the IP address list of the service providing server and the total length of the received IP packet is within an allowable range of the stored packet length range information.

The controller may determine the IP packet to be transmitted over the SDB channel when a source IP address extracted from the received IP packet is contained in the IP address list of the service providing server and an IP packet header of the received IP packet has an effective option field value.

The option field may comprise a data field which comprises information indicating whether the IP packet is to be transmitted over the SDB channel.

According to another exemplary aspect of the present invention, a mobile communication system is provided comprising a service providing server for inserting indication information for transmitting an IP packet received from the Internet over a SDB channel into a header of the IP packet and transmitting the IP packet, and a PDSN for receiving the IP packet from the service providing server, analyzing the IP packet, marking the IP packet to be transmitted over the SDB channel when the IP packet is to be transmitted over the SDB channel, and transmitting the IP packet to a BS/PCF.

The service providing server may set the indication information in an option field of the received header of the IP packet, and the option field may comprise a data field which comprises information indicating whether the IP packet is to be transmitted over the SDB channel.

The PDSN may store an IP address list of the service providing server, and information on an allowable range of a total packet length.

The PDSN may determine the IP packet to be transmitted over the SDB channel if a source IP address extracted from the received IP packet is contained in the IP address list of the service providing server and the total length of the received IP packet is within the allowable range of the total packet length.

The PDSN may determine the IP packet to be transmitted over the SDB channel when a source IP address extracted from the received IP packet is in the IP address list of the service providing server and the header of the received IP packet has an effective option field value.

The service providing server may comprise an IP packet producer which produces an IP packet comprising a signaling message such that the indication information for transmitting the IP packet over the SDB channel is set in a predetermined field of the IP packet when the signaling message for session establishment is received from a mobile station via an IP network.

According to still another exemplary aspect of the present invention, a service providing server is provided for producing an IP packet comprising a signaling message for session establishment such that indication information for transmitting the IP packet over an SDB channel is set in a predetermined field of the IP packet when the signaling message is received from a mobile station via an IP network.

According to yet another exemplary aspect of the present invention, a packet processing method of a mobile communication system is provide comprising the steps of inserting indication information for transmitting an IP packet over an SDB channel into a header of the IP packet containing signaling messages for session establishment and transmitting the IP packet to a PDSN, and receiving the IP packet and analyzing the indication information included in the IP packet to determine whether the IP packet is to be transmitted over the SDB channel.

The packet processing method may further comprise the steps of marking the IP packet to be transmitted over the SDB channel and transmitting the IP packet to the BS/PCF when the received IP packet is selected to be transmitted over the SDB channel.

The marking step may be performed such that when the IP packet is encapsulated in a GRE header, a predetermined field of the GRE header indicates that the 1P packet is a SDB message to be transmitted over the SDB channel when the IP packet is selected to be transmitted over the SDB channel.

The step of analyzing the indication information included in the IP packet to determine whether the IP packet is to be transmitted over the SDB channel may comprise the steps of checking whether a source IP address extracted from the received IP packet is included in the IP address list of the service providing server, and determining the IP packet to be transmitted over the SDB channel when a total length of the received IP packet is within the allowable range of the total packet length.

The step of analyzing the indication information included in the IP packet to determine whether the IP packet is to be transmitted over the SDB channel may comprise the steps of checking whether a source IP address extracted from the received IP packet is included in the IP address list of the service providing server, and determining the IP packet as to be transmitted over the SDB channel when the IP packet is included in the IP address list and a header of the received IP packet has an effective option field value.

The step of analyzing the indication information included in the IP packet to determine whether the IP packet is to be transmitted over the SDB channel may comprise the steps of determining whether a source IP address extracted from the received IP packet is included in the IP address list of the service providing server, determining whether a header of the received IP packet has an option field when the IP packet is included in the IP address list, and determining the IP packet as to be transmitted over the SDB channel when the header of the received IP packet has an option field and the option field has an effective value.

The packet processing method may further comprise the step of ignoring the IP packet if the option field does not have an effective value.

The packet processing method may further comprise the steps of determining whether a total length of the received IP packet is within the allowable range of the total packet length when the header of the received IP packet does not have an option field, and determining the IP packet as to be transmitted over the SDB channel when the total length of the received IP packet is within the allowable range of the total packet length.

According to yet another exemplary aspect of the present invention, a packet processing method of a mobile communication system is provided comprising the steps of storing an IP address list of a service providing server and an allowable range of a total packet length, inserting indication information for transmitting an IP packet over an SDB channel into a header of the IP packet comprising signaling messages for session establishment and transmitting the IP packet to a PDSN, extracting a source IP address from the IP packet received from the service providing server and determining whether the source IP address matches a stored IP address of the service providing server, and marking the IP packet to be transmitted over an SDB channel and transmitting the IP packet to the BS/PCF when the IP packet is selected to be transmitted over the SDB channel.

According to an exemplary implementation of the present invention, storing an IP address list and extracting a source IP address may be performed at a PDSN. According to another exemplary implementation, inserting indication information for transmitting an IP packetover an SDB channel into a header of an SDB channel may be performed at the service providing server.

According to yet another exemplary aspect of the present invention, a packet processing method of a PDSN is provided comprising the steps of reading out a source IP address from a header of an IP packet received from the Internet and determining whether an address matching the source IP address is included in a previously stored list of a service providing server, determining whether the header of the IP packet has an option field when the address matching the source IP address is included in the previously stored list of a service providing server, determining whether a value of the option field is effective when the header of the IP packet has the option field, and marking an indicator for transmitting over an SDB channel onto a predetermined field of a GRE header when the value of the option field is effective.

The packet processing method may further comprise the steps of determining whether a total packet length is within an allowable range stored in the previously stored list of the service providing server when the header of the IP packet does not have the option field, and marking the indicator for transmitting over the SDB channel onto the predetermined field of the GRE header when the total packet length is within the allowable range.

The IP packet may be transmitted in the same way as a standard IP packet without marking the indicator onto the predetermined field of the GRE header when the total packet length is not within the allowable range.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a schematic diagram illustrating an exemplary Code Division Multiple Access (CDMA) network which provides a Push to Talk (PTT) service according to an exemplary embodiment of the present invention;

FIG. 2 is a block diagram of an exemplary service providing server according to an exemplary embodiment of the present invention;

FIG. 3 shows an exemplary header of an Internet Protocol (IP) packet according to an exemplary embodiment of the present invention;

FIG. 4A shows an exemplary option field according to an exemplary embodiment of the present invention;

FIG. 4B shows an exemplary setup of the option field according to an exemplary embodiment of the present invention;

FIG. 5 is a block diagram of an exemplary packet data service node (PDSN) according to an exemplary embodiment of the present invention; and

FIG. 6 is a flowchart illustrating an exemplary procedure for determining whether a packet received at the PDSN is to be transmitted over a short data burst (SDB) channel according to an exemplary embodiment of the present invention.

### DETAILED DESCRIPTION OF EXEMPLARY EMBODIMENTS

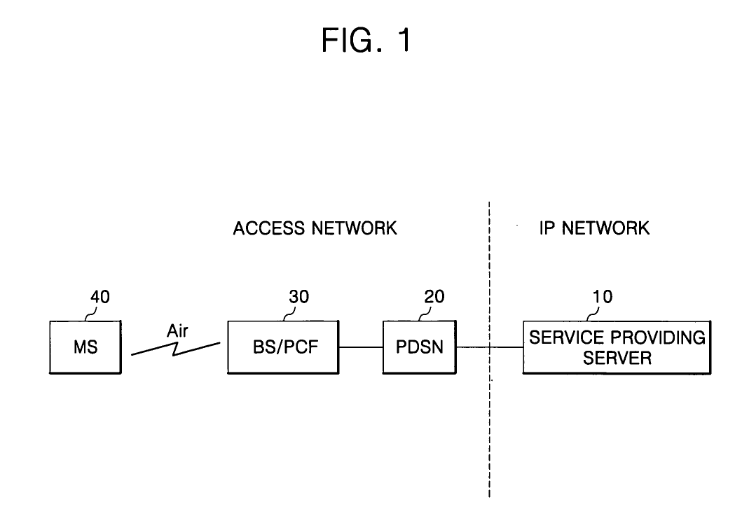

The present invention will now be described more fully with reference to the accompanying drawings, in which exemplary embodiments of the invention are shown. This invention may, however, be embodied in different forms and should not be construed as limited to the exemplary embodiments set forth herein. FIG. 1 is a schematic diagram illustrating a Code Division Multiple Access (CDMA) network which provides a push-to-talk (PTT) service according to an exemplary embodiment of the present invention.

Referring to FIG. 1, the CDMA network which provides a PTT service according to an exemplary embodiment of the present invention comprises a service providing server 10, a packet data serving node (PDSN) 20, a base station/packet control function (BS/PCF) 30, and a mobile station (MS) 40.

In the BS/PCF 30, the PCF may be mounted on a rack of the base station (BS). Here, the BS indicates a system comprising a base station controller (BSC) and a base station transceiver subsystem (BTS).

The service providing server 10 and the PDSN 20 are connected through an IP network, for example, the PDSN 20 and the BS/PCF 30 are connected via a wired network, and the BS/PCF 30 and the mobile station 40 are connected via a radio link.

The service providing server 10 provides a real-time multimedia service by interworking a mobile communication network with the IP network such as in a PTT service, a push to data (PTD) service, and an image message (IM) service.

The service providing server 10 receives a PTT service request from a calling terminal (not shown) and transfers signaling messages for session initiation protocol (SIP) session establishment between the calling terminal and a receiver terminal 40.

The service providing server 10 converts the signaling message for the SIP session establishment to be transmitted to the corresponding mobile station 40 into IP packets and transmits them to the PDSN 20 over an SDB channel in the form of an SDB.

If there is a need to transmit voice data between the PDSN and the PCF, the SDB transfers the data to the mobile station over the signaling channel. Since the amount of data that can be transmitted over the signaling channel is limited, the size of a packet to be transmitted in the form of an SDB is also limited.

In the CDMA 2000 1× system, SDB is a method which can transmit small-sized packets to the mobile station over a SDB channel, such as a paging channel, without allocating a traffic channel and without transitioning the data session from a dormant state to an active state.

The service providing server 10 transmits to the PDSN 20 the IP packet comprising indication information which indicates that the signaling message for SIP session establishment should be transmitted over the SDB channel to the mobile station 40 when the BS/PCF 30 and the mobile station 40 are in the dormant state.

The PDSN 20 stores and manages a list of the service providing servers which can transmit the data over the SDB channel and an effective or efficient packet size. If the source IP address and packet size of the packet received over the Internet are not registered in the PDSN 20, the PDSN 20 ignores or discards the packet or transmits the packet over the traffic channel even though the packet needs to be transmitted over the SDB channel. This is to prevent a non-authorized server from transmitting a SDB packet.

The PDSN 20 establishes a peer-to-peer protocol (PPP) session with the mobile station 40 and converts the call establishment request message into the IP packet and transmits it to the service providing server 10. When an IP packet is received from the service providing server 10, the PDSN 20 determines whether it should be transmitted over the SDB channel from the BS/PCF 30 to the mobile station 40. If it is determined that the IP packet should be transmitted over the SDB channel, the PDSN 20 marks predetermined indication information in the IP packet and transmits it to the BSC/PCF 30.

That is, the PDSN 20 analyzes the IP packet received from the service providing server 10 and comprises the indication information, which causes the IP packet comprising the SDB message to be transmitted over the SDB channel to the mobile station, in a generic routing encapsulation (GRE) header which encapsulates the IP packet and transmits it to the BS/PCF 30.

Here, at the PDSN 20, inserting the indication information into a certain field of the GRE header is referred to as “marking”.

The BS/PCF 30 receives the IP packet encapsulated by the GRE header from the PDSN 20 and analyzes the GRE header. If it is determined that the GRE header has the indication information marked therein, the BS/PCF 30 does not allocate a traffic channel for transmitting the signaling message for the IP packet and transmits the signaling message over the SDB channel while maintaining the dormant state between the BS/PCF 30 and the mobile station 40“as is”.

However, if it is determined that the GRE header does not have the indication information marked therein, the BS/PCF 30 performs a procedure for allocating the traffic channel and transmits the IP packet to the mobile station over the allocated traffic channel.

The mobile station 40 transmits a request message INVITE of a PTT SIP form to the BS/PCF 30 according to a subscriber's selection, and transmits a response message 200 OK when it receives the request message INVITE from the BS/PCF 30.

Operations of the components of FIG. 1 are described in detail below.

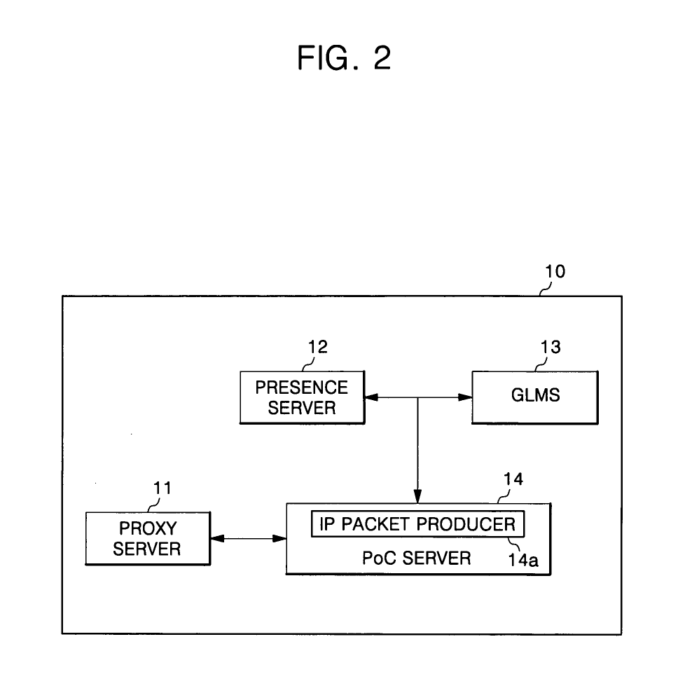

FIG. 2 is a block diagram of an exemplary service providing server according to an exemplary embodiment of the present invention.

Referring to FIG. 2, the service providing server 10 comprises a proxy server 11, a presence server 12, a group list management server (GLMS) 13, and a PPT over cellular (PoC) server 14. The PoC server 14 comprises an IP packet producer 14a.

The presence server 12 of the service providing server 10 manages a connection state of the respective mobile stations 40 which access the service providing server 10.

That is, the presence server 12 manages state information such as a login state, a logout state, an idle state, or a busy state, representing a current connection state of each mobile station 40 authorized to be provided with a PTT service through the service providing server 10, and provides the state information of a corresponding mobile station 40 when a state request message is received from the proxy server 41.

The GLMS 13 manages address information of call receiving terminals set by a subscriber of the mobile station 40 in the form of a list or group.

For example, the GLMS 13 manages address information of other mobile stations registered by the subscriber of the mobile station 40 in the form of a list or group or manages the address information whenever a call session is established according to a setup by the subscriber.

The GLMS 13 provides the address information of the corresponding mobile station when an address request message requesting the address information of the call receiving terminal is received from the PoC server 14.

The address information of the respective mobile stations 40 managed by the GLMS 13 may be information in the form of an e-mail address or a user uniform resource identifier (URI), and bit information which corresponds to the e-mail address information. And, when the address request message is received from the PoC server 14, the GLMS 13 provides the e-mail address information or the bit information of the corresponding mobile station.

The GLMS 13 manages approval information set by each subscriber. For example, the approval information comprises complete or total approval information which indicates that a subscriber of the mobile station 40 approves all call request messages to be received, partial approval information which indicates that call request messages transmitted from a mobile station having certain address information are to be rejected, and total rejection information which indicates that all call request messages are to be rejected.

The GLMS 13 manages ID information (MDN) of the CDMA network of each subscriber, and when the address request message is received, the GLMS 13 provides the address information and the ID information of the CDMA network.

The proxy server 11 receives the IP packet from each PDSN 20 connected thereto via a wired network. When the call request message is received through each PDSN 20 from each mobile station 40, the proxy server 11 checks the connection state of the call receiving terminal through the presence server 12. If the call receiving terminal is in the idle state, the proxy server 11 prompts the corresponding PDSN 20 included in an access network (AN) to transmit the call request message to the call receiving terminal so that a call can be set up between the calling terminal and the call receiving terminal.

If the call receiving terminal is not in the idle state, i.e., it is in a busy state or a logged-out state, the proxy server 11 does not transmit the call request message to the call receiving terminal through the corresponding PDSN 20 but transmits a virtual response message to the PoC server 14 in response to the call request message.

At this time, the proxy server 11 may comprise a message processing means (not shown) for transmitting the virtual response message according to the connection state of the call receiving terminal, or a software program enabling a manufacturer or operator to transmit the virtual response message.

When the call request message is received from the proxy server 11, the PoC server 14 checks the approval information of the call receiving terminal managed by the GLMS 13. If the call receiving terminal is set to receive the call request message transmitted from the calling terminal, the PoC server 11 transmits the call request message to the call receiving terminal through the proxy server 11 connected to the call receiving terminal.

On the other hand, if the call receiving terminal sets the address information of the calling terminal to the rejection information of the partial approval information or the total rejection information, the PoC server 14 performs call failure processing.

If destination information of the call request message transmitted from the calling terminal is a plurality of mobile stations, i.e., the calling terminal transmits the call request message to set up a call with a plurality of mobile stations, the PoC server 14 transmits the call request message to the plurality of call receiving terminals through the respective proxy servers 11 connected to the plurality of call receiving terminals.

According to an exemplary implementation, the PoC server 14 transmits as many call request messages as the number of call receiving terminal addresses included in the received call request message to the plurality of call receiving terminals through the proxy server 11.

The IP packet producer 14a of the PoC server 14 produces an IP packet comprising a signaling message when the signaling message for SIP session establishment is received from a specific mobile station through the Internet. At this time, the identification information is inserted into the predetermined field of the IP packet for transmitting the SDB over the SDB channel.

At this time, the IP packet producer 14a allocates transient ID information to each call established according to the call request message transmitted from the calling terminal, transmits the address request message to the GLMS 13, and produces the IP packet according to the ID information of the CDMA network, which is the address information of the call receiving terminal received from the GLMS 13 and the allocated ID information of the call.

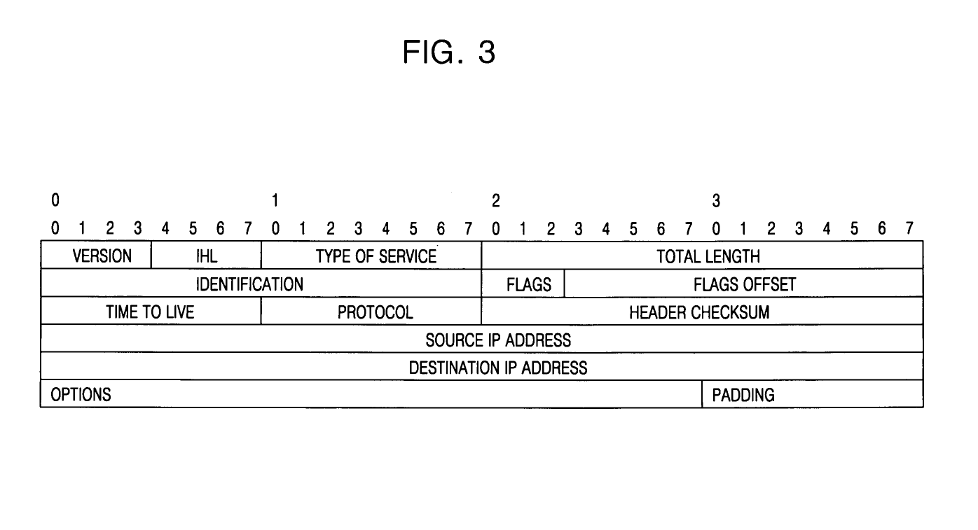

FIG. 3 shows an exemplary header of an IP packet according to an exemplary embodiment of the present invention.

Referring to FIG. 3, the header of the IP packet comprises a version field Version, an IP header length field IHL, a service type field Type Of Service, a total length field Total Length, a packet life span field Time To Live, a protocol field Protocol, a header checksum field Header Checksum, a source IP address field Source IP address, a destination IP address field Destination IP address, an option field Options, and a padding field Padding.

The version field Version comprises version information of the IP packet, such as IPv4 or IPv6.

The IP header length field IHL indicates the length of the IP header, and is set to “6” in FIG. 3.

The service type field Type Of Service indicates a type of a service performed by the IP packet.

The total length field Total Length indicates the total length of the IP packet.

The packet life span field Time To Live indicates a remaining time before discarding the IP packet.

The protocol field Protocol indicates a kind of the protocol used by the IP packet.

The header checksum field Header Checksum indicates whether the IP packet header is damaged.

The source IP address field Source IP address bears the IP address of the service providing server 10 that produced the IP packet.

The destination IP address field Destination IP address bears the IP address of the call receiving terminal that is to receive the IP packet.

The option field Options is where the identification information for transmitting the signaling message included in the IP packet as the SDB over the SDB channel is inserted. According to the option field, it is determined whether the BS/PCF 30 in the dormant state is activated to allocate a traffic channel and transmit the IP packet to the mobile station over the allocated traffic channel or transmits the IP packet to the mobile station over the SDB channel without allocating the traffic channel.

The padding field Padding adjusts the length of the IP packet to a predetermined length.

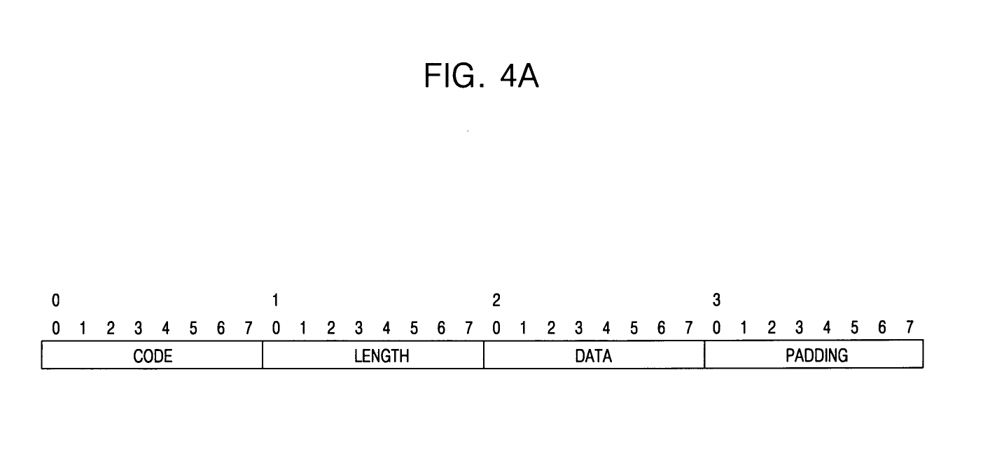

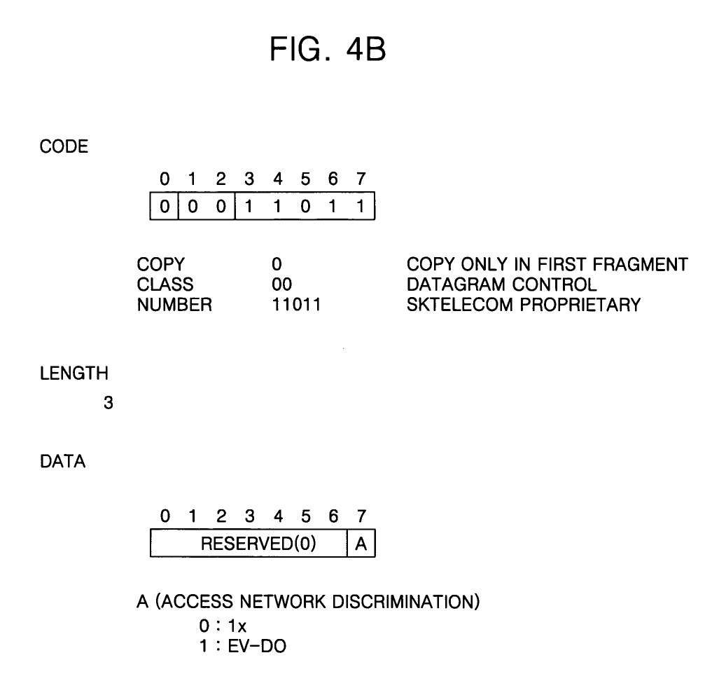

FIG. 4A shows an exemplary option field according to an exemplary embodiment of the present invention.

Referring to FIG. 4A, the option field comprises a code field, a length field, and a data field, which are each allocated one byte.

In the code field, code information of an enterprise is set.

In the length field, a length of the option field is set. Here, the length of the option field is set to 3 bytes, for example.

The data field is set to indicate whether the IP packet is the SDB data.

FIG. 4B shows an exemplary setup of the option field according to an exemplary embodiment of the present invention.

Referring to FIG. 4B, the code field comprises a copy field Copy, a class field Class, and a number field Number. “0”, “00”, and “11011” are respectively set in the copy field, the class field, and the number field.

The copy field represents how many fragments the option field is comprised of, which is indicated in the first fragment. If the copy field is set to “0”, it means that no additional option field is added.

The class field relates to datagram control.

The number field bears an inherent number allocated to a communication enterprise. For example, “11011” is an enterprise identification code allocated to SK Telecom in Korea.

The length field is set to 3, which means that the length of the option field is set to 3 bytes.

The data field is allocated a total of one byte, and one bit of the one byte is used to discriminate the access network. For example, if a corresponding bit is set to “0”, it represents the CDMA 2000 1× network and the corresponding IP packet is the SDB. However, if a corresponding bit is set to “1”, it represents the CDMA 2000 1× EV-DO network and the corresponding IP packet is not the SDB.

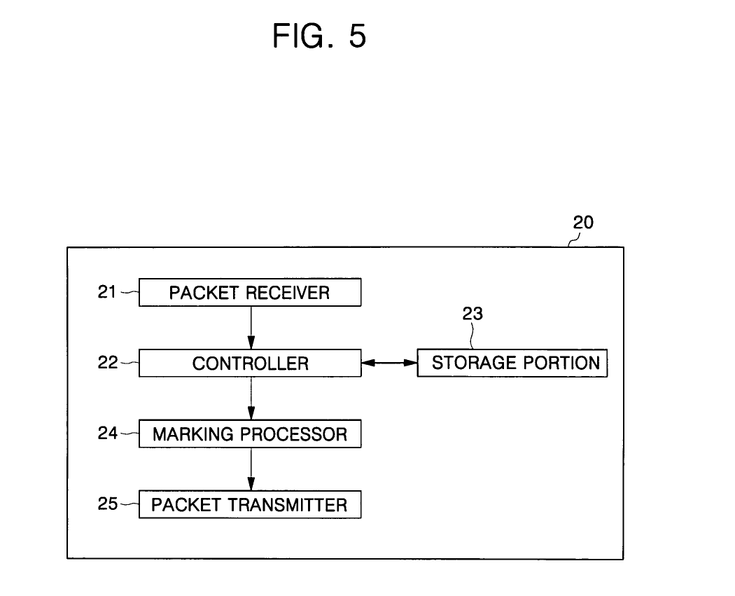

FIG. 5 is an exemplary block diagram of a PDSN according to an exemplary embodiment of the present invention.

Referring to FIG. 5, the PDSN 20 comprises a packet receiver 21, a controller 22, a storage portion 23, a marking processor 24, and a packet transmitter 25.

The packet receiver 21 receives an IP packet from the service providing server 10 and transmits it to the controller 22.

The storage portion 21 stores and manages list information of the service providing servers which are authenticated to use a service for transmitting over the SDB channel and available packet size.

For example, in the storage portion 23, the IP address of the service providing server, the netmask, and packet length range information may be stored in the form of a table.

If the IP address of the service providing server is “165.213.130.1”, the netmask is “255.255.255.0”, and the packet length range is set between 1 and 60, it indicates that a corresponding service is allowed to a service providing server whose IP address ranges from “165.213.130.1” to “165.213.130.254”.

The packet length range of 1 to 60 indicates that the corresponding service is allowed as long as the total length of the corresponding packet is within a range of 1 to 60 bytes.

The controller 22 extracts information of the IP packet received from the service providing service 10 and compares it to a value stored in the storage portion 23 to determine whether to transmit the corresponding IP packet over the SDB channel or the traffic channel.

There are various methods of determining whether the controller 22 transmits the corresponding IP packet received from the service providing server 10 over the SDB channel.

A first method uses the option field of the IP packet header of the IP packet received from the service providing server 10. That is, the controller 22 checks whether the IP packet received from the service providing server 10 has an IP header option and determines that the corresponding IP packet is to be transmitted over the SDB channel if the corresponding IP packet has the IP header option and a value set in the option field is effective.

The source IP address of the corresponding IP packet should be an address which is registered in the list of the service providing server stored in the storage portion 23. Otherwise, the controller 22 ignores the corresponding IP packet.

A second method is used in the case where the service providing server 10 cannot transmit the packet in which the IP header option is set, and it is determined whether the corresponding packet is transmitted over the SDB channel using the list of the service providing server and the packet length range stored in the storage portion 23.

That is, in the case where an IP packet having no IP header option is received, the controller 22 extracts the source IP address and the packet length of the corresponding packet and compares them to values set in the server list stored in the storage portion 23. If they are within an allowable range, the corresponding packet is selected to be transmitted over the SDB channel.

In the case where the packet is determined to be transmitted over the SDB channel, the marking processor 24 marks a certain field of the GRE header with a value for indicating that the packet is the SDB message to be transmitted over the SDB channel when the packet is encapsulated in the GRE header, and transmits it to the packet transmitter 25. The packet transmitter 25 transmits the marked packet to the BS/PCF30. There are various techniques for marking the GRE header which are well known to one of ordinary skill in the art.

If the packet to be transmitted over the SDB channel is a standard message to be transmitted over the traffic channel, the marking processor 24 encapsulates the corresponding packet in the GRE header without marking the certain field of the GRE header.

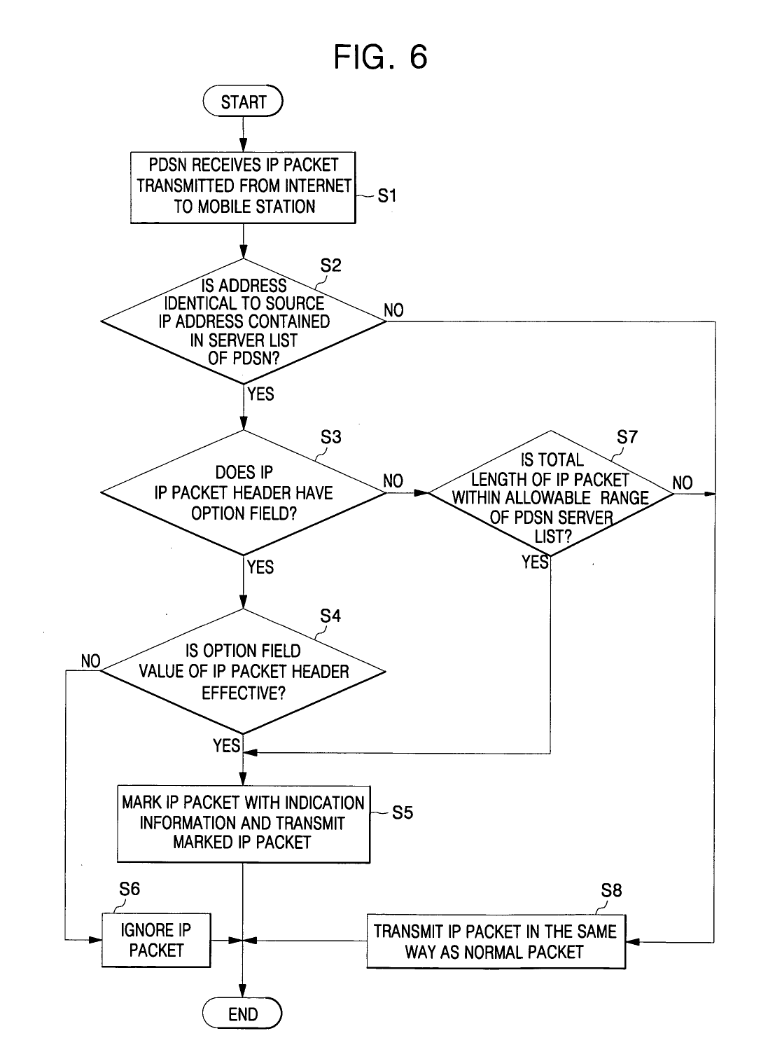

FIG. 6 is a flowchart illustrating an exemplary procedure for determining whether the packet received at the PDSN is to be transmitted over the SDB channel according to an exemplary embodiment of the present invention.

Referring to FIG. 6, the PDSN 20 receives a certain IP packet transmitted from the Internet network to a mobile station at step S1.

The controller 22 of the PDSN 20 reads out a source IP address from the IP packet header to determine whether the list of the service providing server stored in the storage portion 23 of the PDSN 20 comprises an address which matches the source IP address of the corresponding packet at step S2.

If the list of the service providing server stored in the storage portion 23 of the PDSN 20 comprises the address which matches the source IP address of the corresponding packet, it is determined whether the corresponding IP packet has the option field of the IP packet header at step S3.

If the corresponding IP packet has the option field of the IP packet header, it is determined whether the option field value of the IP packet header is effective at step S4.

If the option field value of the IP packet header is effective, an indicator for transmitting the IP packet over the SDB channel is marked in a predetermined field of the GRE header at step S5.

However, if the option field value of the IP packet header is not effective, the corresponding IP packet is ignored at step S6.

Meanwhile, if the corresponding IP packet does not have the option field of the IP packet header, it is determined whether the total packet length is within an allowable range stored in the list of the service providing server of the storage portion 23 at step S7.

If the total packet length is within the allowable range, the indicator for transmitting the IP packet over the SDB channel is marked in the predetermined field of the GRE header at step S5.

However, if the total packet length is not within the allowable range, the corresponding IP packet is transmitted in the same manner as a standard packet without marking the predetermined field of the GRE header at step S8.

As described above, according to exemplary embodiments of the present invention, it is possible to reduce processing delay and traffic channel allocation failure which sometimes occur when a traffic channel, which is a radio resource, is activated during always-on service, thereby effectively managing always-on subscribers at a low cost.

That is, in the case where the PTT service is provided, for example, if the signaling messages for SIP session establishment transmitted by the PTT server are transmitted using the SDB function, the PDSN forwards the signaling message for the SIP session establishment to the mobile station in the dormant state. And, while the mobile station processes the SIP message, the BS/PCF allocates the traffic channel. Thus, the total time required for PTT session establishment can be reduced.

While the present invention has been described with reference to exemplary embodiments thereof, it will be understood by those skilled in the art that various changes in form and detail may be made therein without departing from the scope of the present invention as defined by the following claims

What is claimed is:

1. A packet data serving node (PDSN) comprising an interconnection with a service providing server and a base station/packet control function (BS/PCF),
wherein the PDSN analyzes an Internet Protocol (IP) packet received from the service providing server, and marks the IP packet for transmission over a short data burst (SDB) channel and transmits the marked IP packet to the BS/PCF when the IP packet is selected as a packet to be transmitted over the SDB channel.

2. The PDSN of claim 1, wherein the IP packet comprises a signaling message for session initiation protocol (SIP) session establishment transmitted from the service providing server.

3. The PDSN of claim 2, wherein the signaling message comprises at least one of a session request message and a 200 OK message.

4. The PDSN of claim 1, further comprising:
a storage portion for storing and managing list information of at least one service providing server authenticated to use a service for transmitting over the SDB channel and an effective packet size; and
a controller for extracting and analyzing information related to the IP packet received from the at least one service providing server and comparing the information with a value stored in the storage portion to determine whether the corresponding IP packet is to be transmitted over the SDB channel.

5. The PDSN of claim 4, further comprising:
a marking processor for receiving a packet selected to be transmitted over the SDB channel from the controller and performing generic routing encapsulation (GRE) by marking an indication that the packet is an SDB message to be transmitted over the SDB channel onto the IP packet.

6. The PDSN of claim 4, wherein the storage portion stores at least one of an IP address list of the service providing server, a netmask, and packet length range information in the form of a table.

7. The PDSN of claim 6, wherein the controller determines the IP packet to be transmitted over the SDB channel when the IP address list of the service providing server comprises a source IP address extracted from the received IP packet, and the total length of the received IP packet is within an allowable range of the stored packet length range information.

8. The PDSN of claim 6, wherein the controller determines the IP packet to be transmitted over the SDB channel when the IP address list of the service providing server comprises a source IP address extracted from the received IP packet, and an IP packet header of the received IP packet comprises an effective option field value.

9. The PDSN of claim 8, wherein the option field comprises a data field which comprises information indicating whether the IP packet is to be transmitted over the SDB channel.

10. A mobile communication system, comprising:
a service providing server for inserting indication information for transmitting an Internet Protocol (IP) packet received from the Internet over a short data burst (SDB) channel into a header of the IP packet and transmitting the IP packet; and
a packet data serving node (PDSN) for receiving the IP packet from the service providing server, analyzing the IP packet, marking the IP packet to be transmitted over the SDB channel when the IP packet is to be transmitted over the SDB channel, and transmitting the marked IP packet to a base station/packet control function (BS/PCF).

11. The system of claim 10, wherein the IP packet comprises a signaling message for session initiation protocol (SIP) session establishment transmitted from the service providing server.

12. The system of claim 10, wherein the service providing server sets the indication information in an option field of the received header of the IP packet.

13. The system of claim 12, wherein the option field comprises a data field which comprises information indicating whether the IP packet is to be transmitted over the SDB channel.

14. The system of claim 10, wherein the PDSN stores at least one of an IP address list of the service providing server, and information on an allowable range of a total packet length.

15. The system of claim 14, wherein the PDSN determines the IP packet to be transmitted over the SDB channel when the IP address list of the service providing server comprises a source IP address extracted from the received IP packet, and the total length of the received IP packet is within the allowable range of the total packet length.

16. The system of claim 14, wherein the PDSN determines the IP packet to be transmitted over the SDB channel when the IP address list of the service providing server comprises a source IP address extracted from the received IP packet, and the header of the received IP packet comprises an effective option field value.

17. The system of claim 10, wherein the service providing server comprises an IP packet producer which produces an IP packet comprising a signaling message, and wherein the indication information for transmitting the IP packet over the SDB channel is set in a predetermined field of the IP packet when the signaling message for session establishment is received from a mobile station via an IP network.

18. A service providing server producing an IP packet comprising a signaling message for session establishment, wherein indication information for transmitting the IP packet over an SDB channel is set in a predetermined field of the IP packet when the signaling message is received from a mobile station via an IP network.

19. The server of claim 18, wherein an option field of the IP packet header comprises the indication information.

20. A packet processing method of a mobile communication system, comprising the steps of:
inserting indication information for transmitting an IP packet over a short data burst (SDB) channel into a header of the IP packet comprising signaling messages for session establishment;
transmitting the IP packet;
receiving the IP packet from a service providing server; and
analyzing the indication information to determine whether the IP packet is to be transmitted over the SDB channel.

21. The method of claim 20, further comprising the steps of marking the IP packet to be transmitted over the SDB channel and transmitting the IP packet to a base station/packet control function (BS/PCF) when the received IP packet is selected to be transmitted over the SDB channel.

22. The method of claim 21, wherein the step of marking the IP packet comprises, when the IP packet is encapsulated in a generic routing encapsulation (GRE) header, indicating in a predetermined field of the GRE header indicates that the IP packet comprises a SDB message to be transmitted over the SDB channel when the IP packet is selected to be transmitted over the SDB channel.

23. The method of claim 20, wherein the PDSN stores at least one of an IP address list of the service providing server, and information on an allowable range of a total packet length.

24. The method of claim 23, wherein the step of analyzing the indication information comprises the steps of:
determining whether the IP address list of the service providing server comprises a source IP address extracted from the received IP packet; and
determining that the IP packet is to be transmitted over the SDB channel when a total length of the received IP packet is within the allowable range of the total packet length.

25. The method of claim 23, wherein the step of analyzing the indication information comprises the steps of:
determining whether the IP address list of the service providing server comprises a source IP address extracted from the received IP packet; and
determining that the IP packet to be transmitted over the SDB channel when the IP address list comprises the IP packet and a header of the received IP packet comprises an effective option field value.

26. The method of claim 23, wherein the step of analyzing the indication information comprises the steps of:
determining whether the IP address list of the service providing server comprises a source IP address extracted from the received IP packet;
determining whether a header of the received IP packet comprises an option field when the IP address list comprises the IP packet; and
determining the IP packet to be transmitted over the SDB channel when the header of the received IP packet comprises an option field and the option field comprises an effective value.

27. The method of claim 26, further comprising the step of ignoring the IP packet when the option field does not have an effective value.

28. The method of claim 26, further comprising the steps of:
determining whether a total length of the received IP packet is within the allowable range of the total packet length when the header of the received IP packet does not have an option field; and
determining that the IP packet is to be transmitted over the SDB channel when the total length of the received IP packet is within the allowable range of the total packet length.

29. A packet processing method of a mobile communication system, the method comprising the steps of:
storing an Internet Protocol (IP) address list of a service providing server and an allowable range of a total packet length;
inserting indication information for transmitting an IP packet over a short data burst (SDB) channel into a header of the IP packet comprising signaling messages for session establishment;
transmitting the IP packet;
extracting a source IP address from the IP packet received from the service providing server;
determining whether the source IP address matches a stored IP address of the service providing server;
marking the IP packet to be transmitted over the SDB channel; and
transmitting the marked IP packet to a base station/packet control function (BS/PCF) when the IP packet is selected to be transmitted over the SDB channel.

30. A packet processing method of a PDSN, the method comprising the steps of:
reading out a source Internet Protocol (IP) address from a header of an IP packet received from the Internet;
determining whether a previously stored list of a service providing server comprises an address matching the source IP address;
determining whether the header of the IP packet comprises an option field when the previously stored list of a service providing server comprises the address matching the source IP address;
determining whether a value of the option field is effective when the header of the IP packet comprises the option field; and
marking an indicator for transmitting over an SDB channel onto a predetermined field of a generic routing encapsulation (GRE) header when the value of the option field is effective.

31. The method of claim 30, further comprising the steps of:
determining whether a total packet length is within an allowable range stored in the previously stored list of the service providing server when the header of the IP packet does not have the option field; and
marking the indicator for transmitting over the SDB channel onto the predetermined field of the GRE header when the total packet length is within the allowable range.

32. The method of claim 31, wherein the IP packet is transmitted in the same manner as a standard IP packet without marking the indicator onto the predetermined field of the GRE header when the total packet length is not within the allowable range.
